(19) United States
(12) Patent Application Publication
(10) Pub. No.: US 2025/0083498 A1
(43) Pub. Date: Mar. 13, 2025

(54) Vehicle Visor Device

(71) Applicant: Kelly Coan, Reno, NV (US)

(72) Inventor: Kelly Coan, Reno, NV (US)

(21) Appl. No.: 18/367,317

(22) Filed: Sep. 12, 2023

(51) Int. Cl. B60J 3/02

(52) U.S. Cl. CPC B60J 3/0208; B60J 3/0226

(57) ABSTRACT

A vehicle visor device for reducing glare from sunlight in a vehicle includes a sun visor that is movably mounted to a ceiling of a vehicle which is positionable in a deployed position or a stored position. The sun visor has a top portion comprised of an opaque material to block sunlight for the driver and a bottom portion comprised of a translucent material to pass sunlight through the bottom portion thereby facilitating the driver to see through the bottom portion when the visor is in the deployed position. Additionally, the bottom portion is comprised of a polarized material to reduce glare for the driver when the sun visor is in the deployed position.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to visor devices and more particularly pertains to a new visor device for reducing glare from sunlight in a vehicle. The device includes a sun visor that is mounted in a vehicle which includes a top portion that is comprised of an opaque material and a bottom portion that is comprised of a translucent material.

### (2) Description of Related Art Including Information Disclosed Under 37 CFR 1.97 and 1.98

The prior art relates to visor devices including a variety of sun visors that each includes an opaque portion and a translucent portion that is movably attached to the opaque portion. In no instance does the prior art disclose a sun visor that includes an opaque portion and a translucent portion that is fixedly attached to the opaque portion.

### (h) BRIEF SUMMARY OF THE INVENTION

An embodiment of the disclosure meets the needs presented above by generally comprising a sun visor that is movably mounted to a ceiling of a vehicle which is positionable in a deployed position or a stored position. The sun visor has a top portion comprised of an opaque material to block sunlight for the driver and a bottom portion comprised of a translucent material to pass sunlight through the bottom portion thereby facilitating the driver to see through the bottom portion when the visor is in the deployed position. Additionally, the bottom portion is comprised of a polarized material to reduce glare for the driver when the sun visor is in the deployed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1A is a perspective view of a vehicle visor device according to an embodiment of the disclosure.

FIG. 1B is a perspective view of an alternative embodiment of the disclosure.

FIG. 2 is a front view of an embodiment of the disclosure.

FIG. 3 is a perspective view of an embodiment of the disclosure showing a sun visor being pivoted in a rotating mount.

FIG. 4 is a cross sectional view taken along line 4-4 of FIG. 2 of an embodiment of the disclosure.

FIG. 5 is a back view of an alternative embodiment of the disclosure showing a bottom portion of a sun visor in a stored position.

FIG. 6 is a back view of an alternative embodiment of the disclosure showing a bottom portion of a sun visor in a deployed position.

FIG. 7 is a left side view of an alternative embodiment of the disclosure.

FIG. 8 is a cross sectional view taken along line 8-8 of FIG. 7 of an embodiment of the disclosure.

FIG. 9 is a perspective in-use view of an embodiment of the disclosure.

FIG. 10 is a perspective in-use view of an alternative embodiment of the disclosure.

### (j) DETAILED DESCRIPTION OF THE INVENTION

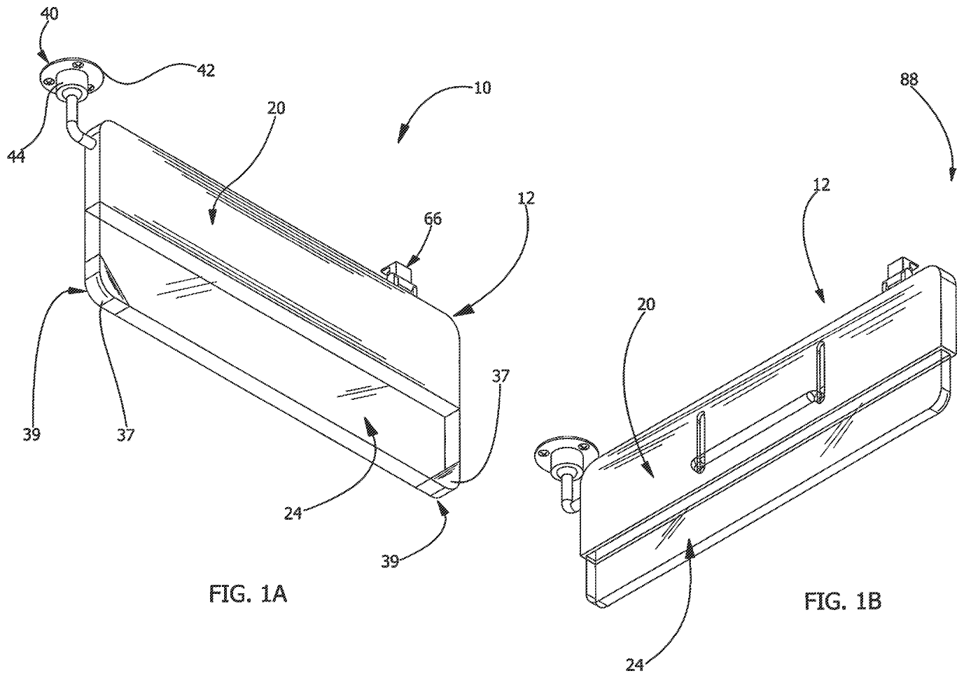

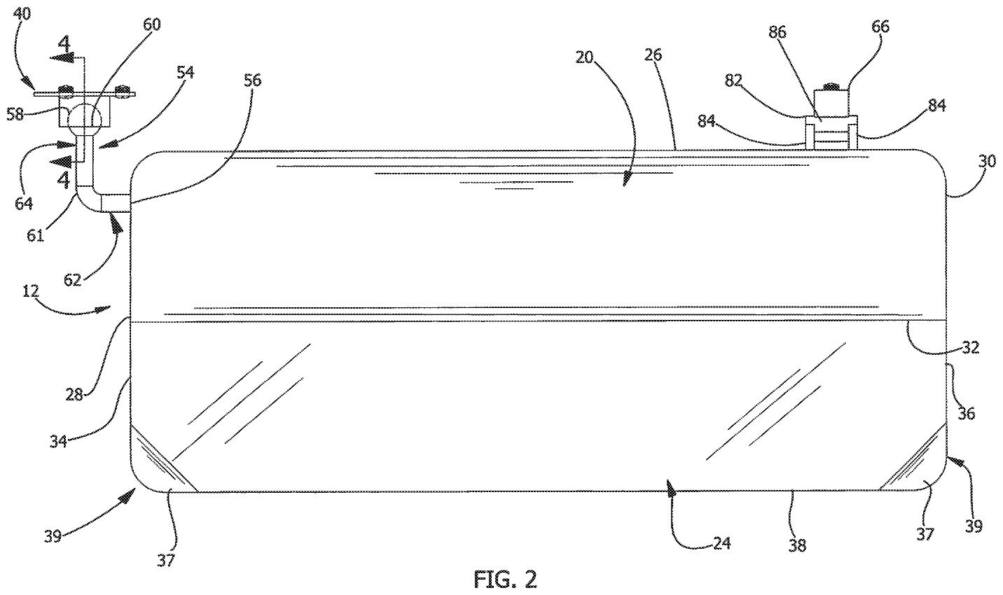

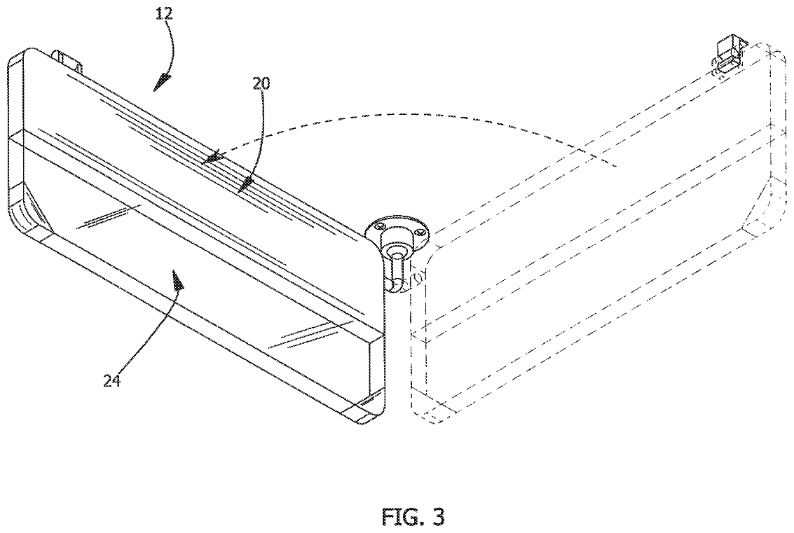

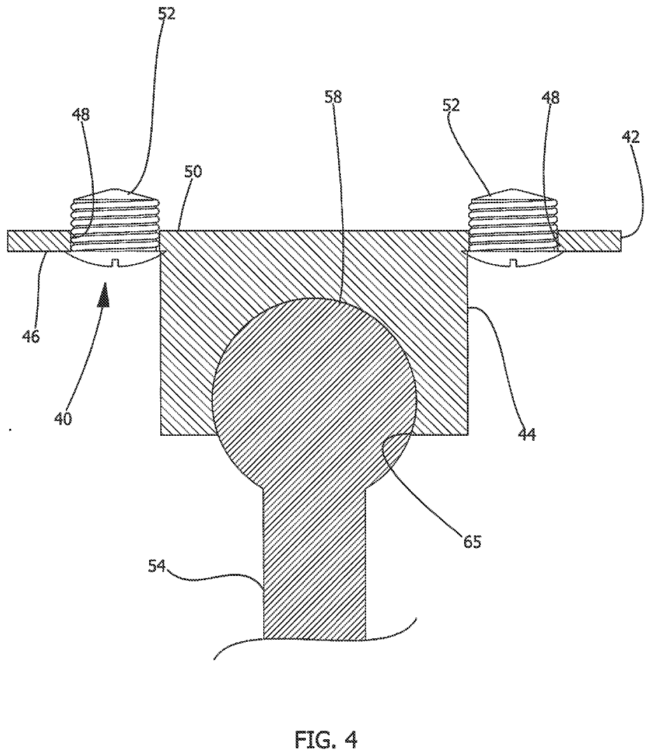

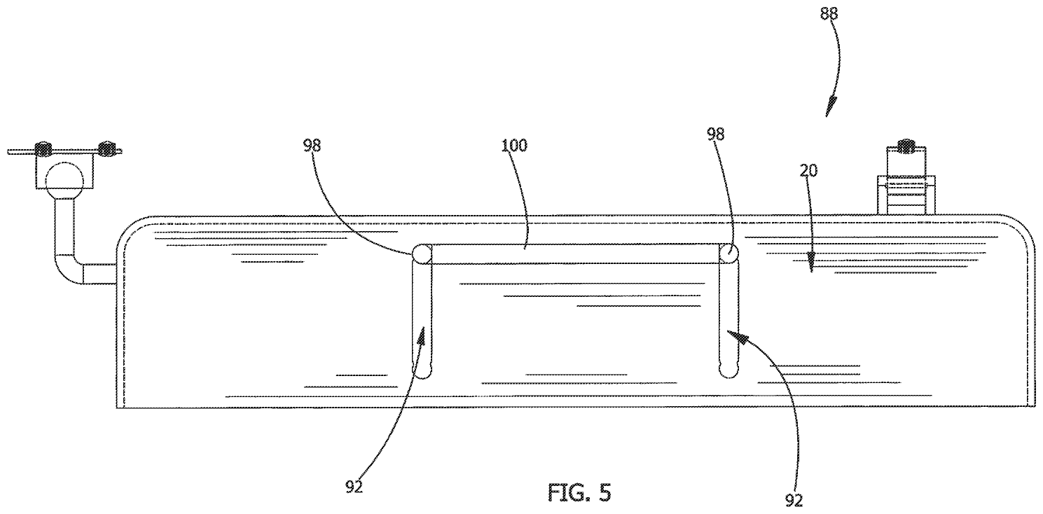

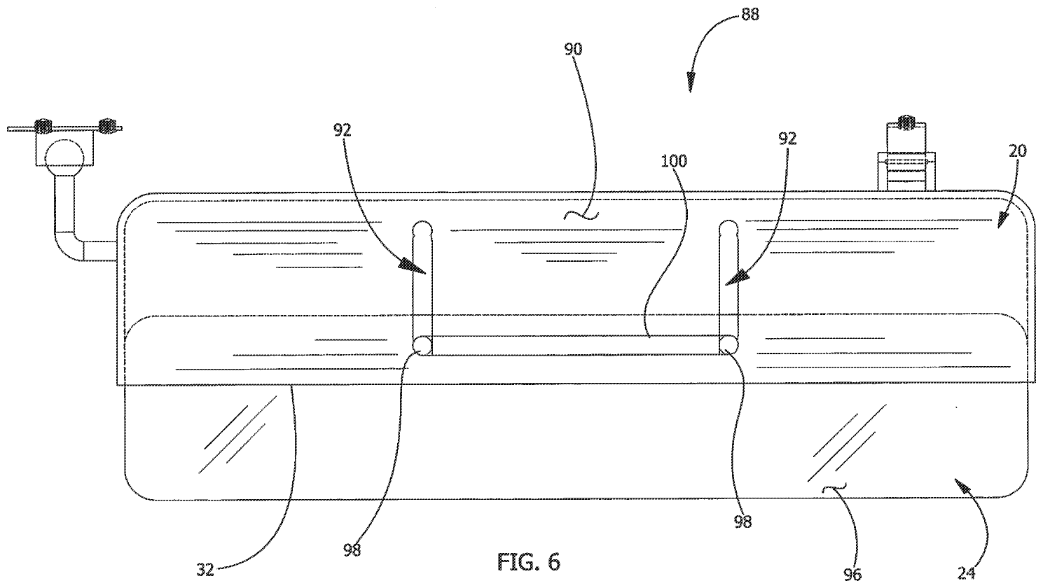

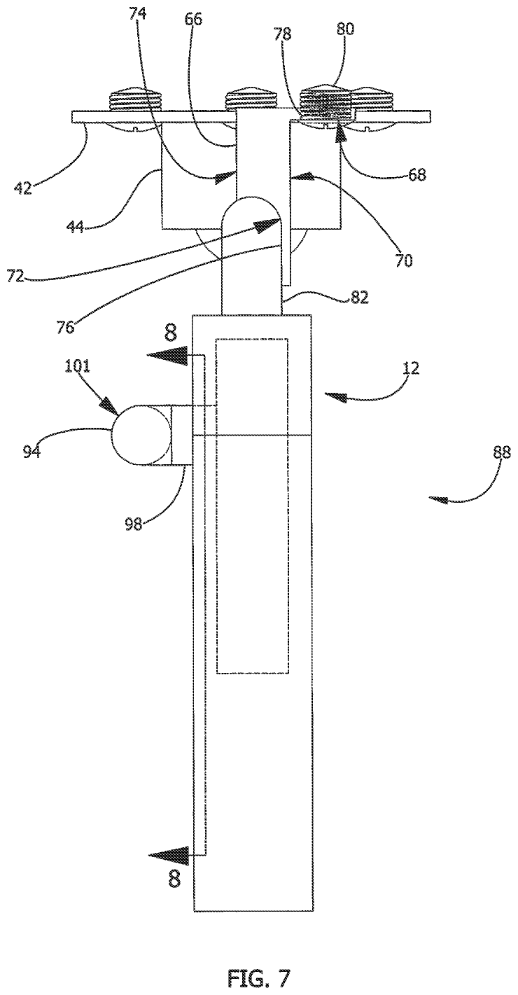

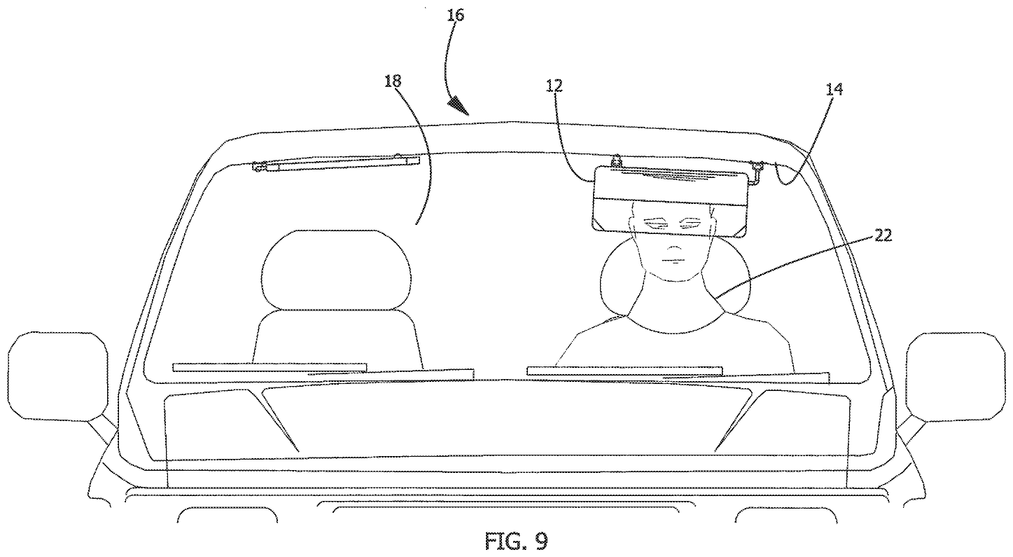

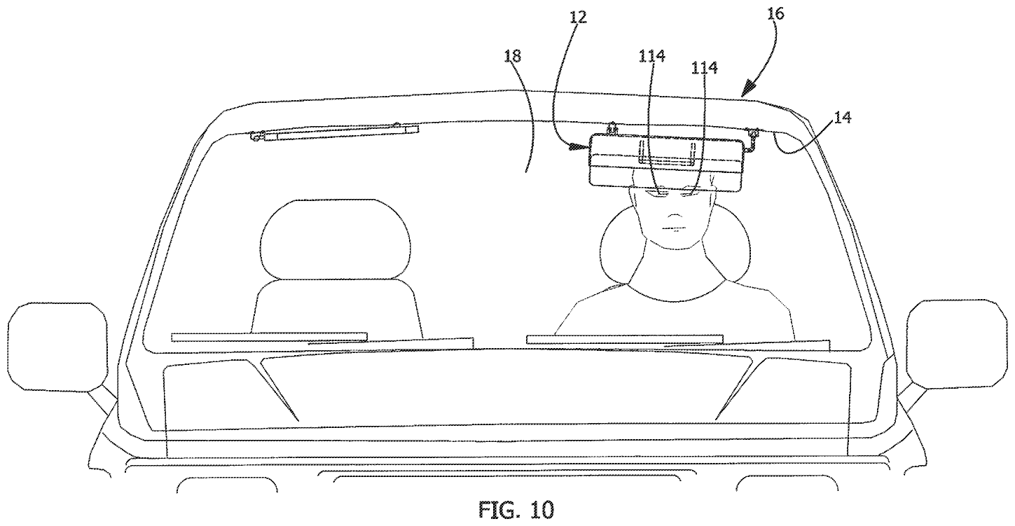

With reference now to the drawings, and in particular to FIGS. 1 through 10 thereof, a new visor device embodying the principles and concepts of an embodiment of the disclosure and generally designated by the reference numeral 10 will be described.

As best illustrated in FIGS. 1 through 10, the vehicle visor device 10 generally comprises a sun visor 12 that is movably mounted to a ceiling 14 of a vehicle 16 having the sun visor 12 being aligned with a windshield 18 of the vehicle 16. The sun visor 12 is positionable in a deployed position having the sun visor 12 extending downwardly along the windshield 18. Conversely, the sun visor 12 is positionable in a stored position having the sun visor 12 resting against the ceiling 14. The vehicle 16 may be a passenger vehicle, a cargo vehicle or any other type of motorized vehicle that is commonly driven on public roadways.

The sun visor 12 has a top portion 20 which is comprised of an opaque material, including but not being limited to plastic wrapped in leather, to block sunlight for a driver 22 of the vehicle 16. In this way the sun visor 12 enhances the driver's 22 ability to see when driving into the sun and when the sun visor 12 is in the deployed position. The sun visor 12 has a bottom portion 24 that is comprised of a translucent material, including but not being limited glass or polycarbonate, to pass sunlight through the bottom portion 24 thereby facilitating the driver 22 to see through the bottom portion 24 when the sun visor 12 is in the deployed position. Furthermore, the bottom portion 24 is comprised of a polarized material to reduce glare for the driver 22 when the sun visor 12 is in the deployed position.

The top portion 20 has a top edge 26, a first lateral edge 28, a second lateral edge 30 and a bottom edge 32 and the top portion 20 is elongated between the first lateral edge 28 and the second lateral edge 30. The bottom portion 24 extends downwardly from the bottom edge 32 and the bottom portion 24 has a first sidelong edge 34, a second sidelong edge 36 and a lower edge 38. Each of the first sidelong edge 34 and the second sidelong edge 36 is aligned with a respective one of the first lateral edge 28 and the second lateral edge 30 of the top portion 20. Additionally, the lower edge 38 is spaced from and is oriented parallel to the bottom edge 32 of the top portion 20. A pair of grips 37 is each wrapped around respective one of a pair of bottom corners 39 of the bottom portion 24. One or both of the grips 37 can be gripped by the driver 22 for urging the sun visor 12 between the stored position and the deployed position to inhibit the bottom portion 24 from becoming obscured with fingerprints.

A rotating mount 40 is attached to the ceiling 14 of the vehicle 16 and the rotating mount 40 includes a base 42 and a cup 44 extending downwardly from a bottom surface 46 of the base 42. The base 42 has a plurality of fastener holes 48 each extending through the bottom surface 46 and a top surface 50 of the base 42. Each of the fastener holes 48 insertably receives a fastener 52, such as a screw for example or other type of penetrating fastener, which engages the ceiling 14 thereby attaching the base 42 to the ceiling 14 having the top surface 50 abutting the ceiling 14. Additionally, the rotating mount 40 is positioned adjacent to the windshield 18.

A rotating arm 54 is coupled to the sun visor 12 and the rotating arm 54 rotatably engages the rotating mount 40 such that the rotating arm 54 is articulable in a variety of orientations in the rotating mount 40. In this way the sun visor 12 can be positioned in a variety of orientations such that the sun visor 12 can block sunlight from a variety of angles with respect to the vehicle 16. The rotating arm 54 has a first end 56 that is coupled to the first lateral edge 28 of the top portion 20 of the sun visor 12 at a point that is located proximate the top edge 26 of the top portion 20. The rotating arm 54 has a ball 58 that is disposed on a second end 60 of the rotating arm 54.

The rotating arm 54 has a bend 61 that is centrally located between the first end 56 and the second end 60 to define a first portion 62 of the rotating arm 54 which forms an angle with a second portion 64 of the rotating arm 54. The first portion 62 is associated with the first end 56 and the second portion 64 is associated with the second end 60. The rotating arm 54 is oriented such that the second portion 64 extends along a line that is oriented parallel to the first lateral edge 28 of the top portion 20. Additionally, the ball 58 is retained in the cup 44 of the rotating mount 40 thereby facilitating the rotating arm 54 to be pivoted in the cup 44. An opening 65 of the cup 44 has a diameter that is less than the diameter of the ball 58 to inhibit the ball 58 from being removed from the cup 44.

A pivot mount 66 is attached to the ceiling 14 of the vehicle 16 and the pivot mount 66 has a leg 68 abutting the ceiling 14 and a foot 70 extending downwardly from the leg 68. The foot 70 has a recess 72 extending into a rear surface 74 of the foot 70 and the recess 72 has a bounding surface 76 that is concavely arcuate with respect to the rear surface 74. The pivot mount 66 has a fastener opening 78 extending through the leg 68. The fastener opening 78 insertably receives a fastener 80, such as a screw for example or other type of penetrating fastener, which engages the ceiling 14 thereby attaching the pivot mount 66 to the ceiling 14. The pivot mount 66 is positioned adjacent to the windshield 18 and the pivot mount 66 is laterally spaced from the rotating mount 40 along the windshield 18.

A latch 82 is provided and the latch 82 is coupled to the sun visor 12. The latch 82 releasably engages the pivot mount 66 for retaining the sun visor 12 in an orientation having the sun visor 12 extending laterally along the windshield 18. In this way the sun visor 12 can be positioned between the deployed position and the stored position when the latch 82 is engaged to the pivot mount 66. The sun visor 12 is pivotable in the rotating mount 40 when the latch 82 is disengaged from the pivot mount 66.

The latch 82 comprises a pair of uprights 84 which each extends upwardly from the top edge 26 of the top portion 20 and a central member 86 which extends between the pair of uprights 84 having the central member 86 being spaced from the top edge 26. The latch 82 is positioned closer to the second lateral edge 30 of the top portion 20 than the first lateral edge 28 of the top portion 20. The central member 86 extends into the recess 72 in the rear surface 74 of the foot 70 of the pivot mount 66 when the latch 82 releasably engages the pivot mount 66. The central member 86 is rotatable in the recess 72 having the central member 86 conforming to curvature of the bounding surface 76 of the recess 72. In this way the central member 86 can rotate in the recess 72 for positioning the sun visor 12 between the deployed position and the stored position.

In an alternative embodiment 88 shown in figures in 1B, 5, 6, 7, 8 and 10, the top portion 20 of the sun visor 12 is substantially hollow and the bottom edge 32 of the top portion 20 is open to access an interior of the top portion 20. The bottom portion 24 extends into the bottom edge 32 and the bottom portion 24 is positionable in a stored position having the bottom portion 24 being contained within the top portion 20. Conversely, the bottom portion 24 is positionable in a deployed position having the bottom portion 24 extending downwardly from the top portion 20. A rear surface 90 of the top portion 20 has a pair of slots 92 that each extends into the interior and each of the slots 92 is oriented to extend substantially between the top edge 26 and the bottom edge 32. Additionally, the slots 92 are positioned on opposite sides of a center of the top portion 20.

Continuing in the alternative embodiment 88, a handle 94 is attached to a back surface 96 of the bottom portion 24 and the handle 94 has a pair of stems 98 each extending away from the back surface 96. Each of the stems 98 extends outwardly through a respective one of the pair of slots 92 in the rear surface 74 of the top portion 20. The handle 94 has a member 100 which extends between a distal end 101 of each of the pair of stems 98 having the member 100 being spaced from the rear surface 74 of the top portion 20. In this way the member 100 can be gripped to manipulate the bottom portion 24 between the stored position and the deployed position.

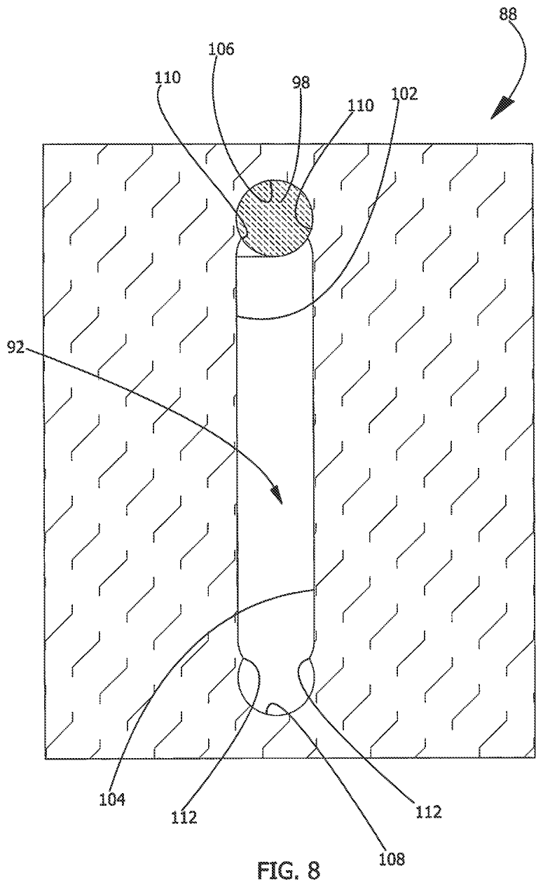

As is most clearly shown in FIG. 8, each of the slots 92 has a first lateral bounding edge 102, a second lateral bounding edge 104, a first terminal end 106 and a second terminal end 108. The first lateral bounding edge 102 and the second lateral edge 30 each has a pair of first points 110 extending toward each other. Additionally, the first lateral bounding edge 102 and the second lateral bounding edge 104 each has a pair of second points 112 extending toward each other. The first points 110 are spaced from the first terminal end 106 and the second points 112 are spaced from the second terminal end 108. The first points 110 removably retain the stem 98 in the respective slot 92 against the first terminal end 106 for releasably retaining the bottom portion 24 in the stored position. Additionally, the second points 112 removably retain the stem 98 in the respective slot 92 against the second terminal end 108 for releasably retaining the bottom portion 24 in the deployed position.

In use, the sun visor 12 is positioned in the deployed position when the driver 22 is driving into the sun thereby facilitating the top portion 20 of the sun visor 12 to shade the driver's eyes 114. Additionally, the bottom portion 24 of the sun visor 12 facilitates the driver 22 to see through the bottom portion 24 while reducing glare for the driver 22. In this way the driver 22 has a larger field of view as compared to traditional sun visors in vehicles due to being able to see through the bottom portion 24 while still being protected from intense and unfiltered sunlight. In the alternative embodiment 88, the handle 94 is gripped to urge the bottom portion 24 into the deployed position, if so desired, or the sun visor 12 can be employed with the bottom portion 24 in the stored position, depending on the driver's 22 preference.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle visor device which has an opaque portion and a polarized translucent portion for shielding a driver from sunlight while driving, said device comprising:
a sun visor being movably mounted to a ceiling of a vehicle having said sun visor being aligned with a windshield of said vehicle, said sun visor being positionable in a deployed position having said sun visor extending downwardly along said windshield, said sun visor being positionable in a stored position having said sun visor resting against said ceiling, said sun visor having a top portion being comprised of an opaque material wherein said top portion is configured to block sunlight for the driver thereby enhancing the driver's ability to see when driving into the sun and when said sun visor is in said deployed position, said sun visor having a bottom portion being comprised of a translucent material wherein said bottom portion is configured to pass sunlight through said bottom portion thereby facilitating the driver to see through said bottom portion when said visor is in said deployed position, said bottom portion being comprised of a polarized material wherein said bottom portion is configured to reduce glare for the driver when said sun visor is in said deployed position;
a rotating mount being attached to said ceiling of said vehicle;
a rotating arm being coupled to said sun visor, said rotating arm rotatably engaging said rotating mount such that said rotating arm is articulable in a variety of orientations in said rotating mount thereby facilitating said sun visor to be positioned in a variety of orientations wherein said sun visor is configured to be positionable to block sunlight from a variety of angles with respect to said vehicle;
a pivot mount being attached to said ceiling of said vehicle; and
a latch being coupled to said sun visor, said latch releasably engaging said pivot mount for retaining said sun visor in an orientation having said sun visor extending laterally along said windshield, said sun visor being pivotable in said rotating mount when said latch is disengaged from said pivot mount.

2. The device according to claim 1, wherein:
said top portion has a top edge, a first lateral edge, a second lateral edge and a bottom edge, said top portion being elongated between said first lateral edge and said second lateral edge; and
said bottom portion extends downwardly from said bottom edge, said bottom portion having a first sidelong edge, a second sidelong edge and a lower edge, each of said first sidelong edge and said second sidelong edge being aligned with a respective one of said first lateral edge and said second lateral edge of said top portion, said lower edge being spaced from and being oriented parallel to said bottom edge of said top portion.

3. The device according to claim 1, wherein:
said rotating mount includes a base and a cup extending downwardly from a bottom surface of said base;
said base has a plurality of fastener holes each extending through said bottom surface and a top surface of said base, each of said fastener holes insertably receiving a fastener which engages said ceiling thereby attaching said base to said ceiling having said top surface abutting said ceiling; and
said rotating mount is positioned adjacent to said windshield.

4. The device according to claim 3, wherein:
said rotating arm has a first end being coupled to said first lateral edge of said top portion of said sun visor at a point being located proximate said top edge of said top portion;
said rotating arm has a ball being disposed on a second end of said rotating arm;
said rotating arm has a bend being centrally located between said first end and said second end to define a first portion of said rotating arm forming an angle with a second portion of said rotating arm, said first portion being associated with said first end, said second portion being associated with said second end;
said rotating arm is oriented such that said second portion extends along a line being oriented parallel to said first lateral edge of said top portion; and
said ball is retained in said cup of said rotating mount thereby facilitating said rotating arm to be pivoted in said cup.

5. The device according to claim 1, wherein said pivot mount has a leg abutting said ceiling and a foot extending downwardly from said leg, said foot having a recess extending into a rear surface of said foot, said pivot mount having a fastener opening extending through said leg, said fastener opening insertably receiving a fastener which engages said ceiling thereby attaching said pivot mount to said ceiling, said pivot being positioned adjacent to said windshield, said pivot mount being laterally spaced from said rotating mount along said windshield.

6. The device according to claim 5, wherein:
said latch comprises a pair of uprights each extending upwardly from said top edge of said top portion and a central member extending between said pair of uprights having said central member being spaced from said top edge;
said latch is positioned closer to said second lateral edge of said top portion than said first lateral edge of said top portion;
said central member extends into said recess in said rear surface of said foot of said pivot mount when said latch releasably engages said pivot mount; and
said central member is rotatable in said recess having said central member conforming to curvature of said bounding surface of said recess thereby facilitating said central member to rotate in said recess for positioning said sun visor between said deployed position and said stored position.

7. A vehicle visor device which has an opaque portion and a polarized translucent portion for shielding a driver from sunlight while driving, said device comprising:
a sun visor being movably mounted to a ceiling of a vehicle having said sun visor being aligned with a windshield of said vehicle, said sun visor being positionable in a deployed position having said sun visor extending downwardly along said windshield, said sun visor being positionable in a stored position having said sun visor resting against said ceiling, said sun visor having a top portion being comprised of an opaque material wherein said top portion is configured to block sunlight for the driver thereby enhancing the driver's ability to see when driving into the sun and when said sun visor is in said deployed position, said sun visor having a bottom portion being comprised of a translucent material wherein said bottom portion is configured to pass sunlight through said bottom portion thereby facilitating the driver to see through said bottom portion when said visor is in said deployed position, said bottom portion being comprised of a polarized material wherein said bottom portion is configured to reduce glare for the driver when said sun visor is in said deployed position, said top portion having a top edge, a first lateral edge, a second lateral edge and a bottom edge, said top portion being elongated between said first lateral edge and said second lateral edge, said bottom portion extending downwardly from said bottom edge, said bottom portion having a first sidelong edge, a second sidelong edge and a lower edge, each of said first sidelong edge and said second sidelong edge being aligned with a respective one of said first lateral edge and said second lateral edge of said top portion, said lower edge being spaced from and being oriented parallel to said bottom edge of said top portion;
a rotating mount being attached to said ceiling of said vehicle, said rotating mount including a base and a cup extending downwardly from a bottom surface of said base, said base having a plurality of fastener holes each extending through said bottom surface and a top surface of said base, each of said fastener holes insertably receiving a fastener which engages said ceiling thereby attaching said base to said ceiling having said top surface abutting said ceiling, said rotating mount being positioned adjacent to said windshield;
a rotating arm being coupled to said sun visor, said rotating arm rotatably engaging said rotating mount such that said rotating arm is articulable in a variety of orientations in said rotating mount thereby facilitating said sun visor to be positioned in a variety of orientations wherein said sun visor is configured to be positionable to block sunlight from a variety of angles with respect to said vehicle, said rotating arm having a first end being coupled to said first lateral edge of said top portion of said sun visor at a point being located proximate said top edge of said top portion, said rotating arm having a ball being disposed on a second end of said rotating arm, said rotating arm having a bend being centrally located between said first end and said second end to define a first portion of said rotating arm forming an angle with a second portion of said rotating arm, said first portion being associated with said first end, said second portion being associated with said second end, said rotating arm being oriented such that said second portion extends along a line being oriented parallel to said first lateral edge of said top portion, said ball being retained in said cup of said rotating mount thereby facilitating said rotating arm to be pivoted in said cup;
a pivot mount being attached to said ceiling of said vehicle, said pivot mount having a leg abutting said ceiling and a foot extending downwardly from said leg, said foot having a recess extending into a rear surface of said foot, said recess having a bounding surface being concavely arcuate with respect to said rear surface, said pivot mount having a fastener opening extending through said leg, said fastener opening insertably receiving a fastener which engages said ceiling thereby attaching said pivot mount to said ceiling, said pivot being positioned adjacent to said windshield, said pivot mount being laterally spaced from said rotating mount along said windshield; and
a latch being coupled to said sun visor, said latch releasably engaging said pivot mount for retaining said sun visor in an orientation having said sun visor extending laterally along said windshield, said sun visor being pivotable in said rotating mount when said latch is disengaged from said pivot mount, said latch comprising a pair of uprights each extending upwardly from said top edge of said top portion and a central member extending between said pair of uprights having said central member being spaced from said top edge, said latch being positioned closer to said second lateral edge of said top portion than said first lateral edge of said top portion, said central member extending into said recess in said rear surface of said foot of said pivot mount when said latch releasably engages said pivot mount, said central member being rotatable in said recess having said central member conforming to curvature of said bounding surface of said recess thereby facilitating said central member to rotate in said recess for positioning said sun visor between said deployed position and said stored position.

8. The device according to claim 7, wherein:
said top portion of said sun visor is substantially hollow, said bottom edge of said top portion being open to access an interior of said top portion;
said bottom portion extending into said bottom edge, said bottom portion being positionable in a stored position having said bottom portion being contained within said top portion, said bottom portion being positionable in a deployed position having said bottom portion extending downwardly from said top portion; and
a rear surface of said top portion has a pair of slots each extending into said interior, each of said slots being oriented to extend substantially between said top edge and said bottom edge, said pair of slots being positioned on opposite sides of a center of said top portion.

9. The device according to claim 8, further comprising a handle being attached to a back surface of said bottom portion, said handle having a pair of stems each extending away from said back surface, each of said stems extending outwardly through a respective one of said pair of slots in said rear surface of said top portion, said handle having a member extending between a distal end of each of said pair of stems having said member being spaced from said rear surface of said top portion wherein said member is configured to be gripped to manipulate said bottom portion between said stored position and said deployed position.
